(19) United States
(12) Patent Application Publication
(10) Pub. No.: US 2019/0358924 A1
(43) Pub. Date: Nov. 28, 2019

(54) FILM APPLYING APPARATUS, EL DEVICE MANUFACTURING APPARATUS, EL DEVICE MANUFACTURING METHOD, AND CONTROLLER

(71) Applicant: Sharp Kabushiki Kaisha, Sakai City, Osaka (JP)

(72) Inventor: Kouji FURUHASHI, Sakai City (JP)

(21) Appl. No.: 16/064,467

(22) PCT Filed: Mar. 24, 2017
(86) PCT No.: PCT/JP2017/012022

§ 371 Date: Jun. 21, 2018

(51) Int. Cl. B30B 5/02; B30B 9/22; G09F 9/30

(52) U.S. Cl. CPC B30B 5/02; G09F 9/301; B30B 9/22

(57) ABSTRACT

A film applying apparatus includes a stage configured to place a cover glass on the stage, a curved surface being formed on the cover glass, an air bag disposed on a position facing to the curved surface across a film, the film being applied to the curved surface, a supporting member configured to support the air bag; and a push-out arm disposed at the supporting member to press the film toward the curved surface of the cover glass.

### TECHNICAL FIELD

The disclosure relates to a film applying apparatus configured to apply a film, such as an Electroluminescence (EL) device on which an EL element is formed, to a casing or the like having a curved plane using an air bag, an EL device manufacturing apparatus, an EL device manufacturing method, and a controller.

### BACKGROUND ART

In the related art, there has been known a liquid crystal display panel manufacturing method including applying an adhesive to the peripherals of a first substrate and a second substrate spaced at a predetermined distance to provide a seal, and injecting a liquid crystal therebetween, in which a cell gap is formed by gradually pressing an air bag against one of the substrates from the center to peripheral edges of the one of the substrate, so that air between the two substrates is expelled (PTL 1).

Furthermore, there has been known an adhesion apparatus configured to adhere an article to be applied (hereinafter, referred to as “intended article”) to one side of a plate-like body having curved surfaces (PTL 2) at a uniform pressure with a predetermined gap between a fist substrate and a second substrate. The applying apparatus includes a pressing portion configured to press the intended article against a plate-like body, and a supporting portion configured to support the plate-like body on one side of the plate-like body opposite the intended article at a location corresponding to the region at which the intended article is located when the intended article is pressed by the pressing portion, the area of the supporting portion being greater than the area of the intended article to be applied to the plate-like body, and the supporting portion has a supporting face conforming to the curved shape of the one side of the plate-like body.

### CITATION LIST

### Patent Literature

PTL 1: JP 2001-255540 A (published Sep. 21, 2001)

PTL 2: JP 2015-98516 A (published May 28, 2015)

### SUMMARY

### Technical Problem

These days, there is an increasing demand for an apparatus configured to apply an application material such as an adhesive, a tape, and a film to a casing or the like having a curved surface. For example, for a display panel including a curved surface formed therein, such as a display panel on which a flexible EL device is formed, an air bag is used when applying a film, on which the EL device is formed, to a cover glass having a curved surface.

However, there is a problem that when the film is pressed against the curved surface of the cover glass by the air bag, a part to which the film is not sufficiently pressed by the air bag locally occurs on the curved surface of the cover glass. In other words, the entire surface of the film may not be sufficiently pressed so that the film reaches throughout the curved surface of the cover glass.

For example, the film may not be sufficiently pressed so that the film may not reach the bottom portion of the concave of the curved surface of the cover glass. In this case, a gap may be created, and in turn an air bubble is produced, between a part of the film not reaching the bottom portion of the concave of the curved surface and the bottom of the concave of the cover glass.

### Solution to Problem

A film applying apparatus according to one aspect of the disclosure includes a stage configured to place a target member on the stage, a curved surface being formed on the target member, an air bag disposed on a position facing to the curved surface across a film, the film being applied to the curved surface of the target member placed on the stage, a supporting member configured to support the air bag; and one or more push-out arms disposed at the supporting member such that the one or more push-out arms project toward an inner surface of the air bag to press the film toward the curved surface formed on the target member.

### Advantageous Effects of Disclosure

According to the one aspect of the disclosure, it is possible to sufficiently apply a film to a member to which the film is applied (hereinafter, referred to as “target member”) on which a curved surface is formed.

### BRIEF DESCRIPTION OF DRAWINGS

FIG. 1 is a sectional view schematically illustrating a configuration of a film applying apparatus according to a first embodiment.

FIG. 2 is a sectional view for explaining operations of the film applying apparatus above.

FIG. 3 is a sectional view schematically illustrating a configuration of a film applying apparatus according to a comparative example.

FIG. 4 is a sectional view for explaining operations of the film applying apparatus above.

FIG. 5 is a sectional view schematically illustrating a configuration of a film applying apparatus according to a second embodiment.

FIG. 6 is a sectional view for explaining operations of the film applying apparatus above.

FIG. 7 is a sectional view schematically illustrating a configuration of a film applying apparatus according to another comparative example.

FIG. 8 is a sectional view for explaining operations of the film applying apparatus above.

### DESCRIPTION OF EMBODIMENTS

### First Embodiment

### Configuration of Film Applying Apparatus 1

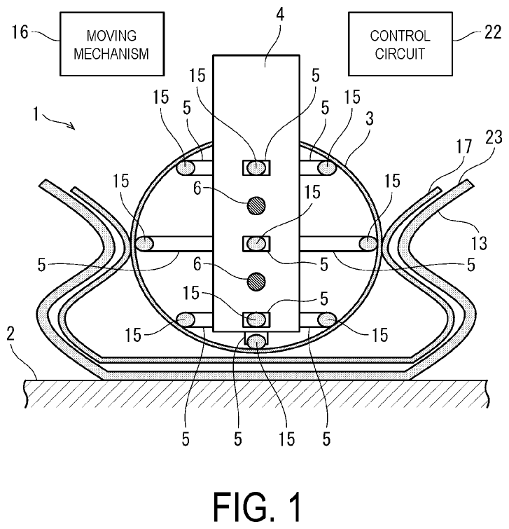

FIG. 1 is a sectional view schematically illustrating a configuration of a film applying apparatus 1 according to a first embodiment. The film applying apparatus 1 includes a stage 2. A casing 13 (a target member) provided with a complexly-deformed curved surface is placed on the stage 2.

The film applying apparatus 1 includes an air bag 3 made of rubber. The air bag 3 is disposed at a position opposite an inner curved surface 23 across a film 17 to be applied to the inner curved surface 23. The inner curved surface is a curved surface inside the casing 13 placed on the stage 2.

For example, the film 17 may be, but not limited to, an Organic Light Emitting Diode (OLED) flat surface film on which an EL device is formed. Alternatively, the film 17 may be, for example, an Optical Clear Adhesive sheet (OCA), a Polarizer (POL), or a touch panel.

The film 17 as a flexible display is flexible, and is not particularly limited so long as it is a display panel including a bendable optical element. The aforementioned optical element is an optical element and the luminance and the transmittance of the optical element are controlled by an electric current. Such current-controlled optical elements include an EL display such as an organic Electro luminescence (EL) display including Organic Light Emitting Diodes (OLEDs) or an inorganic EL display including inorganic light emitting diodes, a Quantum dot Light Emitting Diode (QLED) display including QLEDs, etc.

The film applying apparatus 1 includes a supporting member 4 configured to support the air bag 3. The supporting member 4 is disposed so that the supporting member projects toward the interior of the air bag 3. A plurality of air discharging ports 6 is formed in the supporting member to discharge the air 10 toward the inner curved surface 23 of the casing 13 to inflate the air bag 3 so that the film 17 is pressed against the inner curved surface 23.

The supporting member 4 includes a plurality of push-out arms 5 configured to push the film 17 toward the inner curved surface 23 of the casing 13. Each push-out arm 5 is a rod-like extendable member provided in a manner horizontally projecting from the side surface of the supporting member 4 toward the inner surface of the air bag 3.

At a distal end of each push-out arm 5, a connecting member 15 is disposed and configured to connect the air bag 3 and the push-out arm 5.

Some of the push-out arms 5 are deployed at a position corresponding to a bulging portion of the inner curved surface 23 of the casing 13. Some other push-out arms 5 are deployed at a position corresponding to a recessed portion of the inner curved surface 23 of the casing 13.

In the example illustrated in FIG. 1, a bulging portion is formed on the inner curved surface 23 of the casing 13. Furthermore, a recessed portion is formed therein under the bulging portion. Furthermore, another recessed portion is formed therein above the bulging portion. Four push-out arms 5 configured to project from the side surface of the supporting member 4 in four directions are deployed at the position corresponding to the bulging portion of the inner curved surface 23. Other four push-out arms 5 configured to project in four directions are deployed at the position corresponding to the recessed portion under the aforementioned bulging portion. Furthermore, other four push-out arms 5 configured to project in four directions are deployed at the position corresponding to the recessed portion above the aforementioned bulging portion. Furthermore, other push-out arms 5 configured to project downwardly is disposed at the lower surface of the supporting member 4.

The film applying apparatus 1 includes a moving mechanism 16. The moving mechanism 16 vertically and horizontally moves the supporting member 4, inserts the supporting member 4 into the casing 13, and disposes some of the push-out arms 5 at the position corresponding the bulging portion of the inner curved surface 23 of the casing 13.

The film applying apparatus 1 includes a control circuit 22. The control circuit 22 controls extension and retraction of the push-out arms 5 so that the film 17 is pressed toward the inner curved surface 23 of the casing 13.

### Operations of Film Applying Apparatus 1

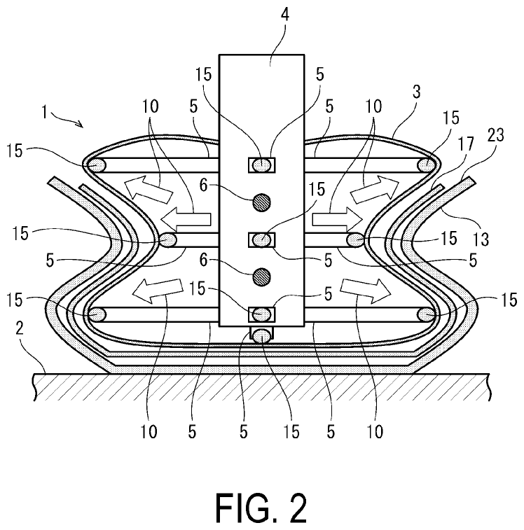

FIG. 2 is a sectional view for explaining operations of the film applying apparatus 1.

The film applying apparatus 1 configured as described above operates as follows. Referring to FIG. 1, first, the film 17 is provided along the inner curved surface 23 of the casing 13. Then, the moving mechanism 16 moves the supporting member 4 into the casing 13 in which the film 17 has been provided so that the four push-out arms 5 are disposed on the position corresponding to the bulging portion of the inner curved surface 23, other four push-out arms 5 are disposed on the position corresponding to the recessed portion under the bulging portion, and other four push-out arms 5 are disposed on the position corresponding to the recessed portion above the bulging portion.

Next, referring to FIG. 2, air 10 is discharged from the air discharging ports 6, so that the air bag 3 is inflated. After that, other four push-out arms 5 corresponding to the lower recessed portion extend in four directions, and thereby push the air bag 3. Thus, the film 17 is pushed toward the lower recessed portion of the inner curved surface 23 of the casing 13 by the air bag 3. As a result, the film 17 is also sufficiently applied to the lower recessed portion of the casing 13.

Then, other four push-out arms 5 corresponding to the upper recessed portion extend in four directions and thereby push the air bag 3. Thus, the film 17 is pressed toward the upper recessed portion of the inner curved surface 23 of the casing 13 by the air bag 3. As a result, the film 17 is also sufficiently applied to the upper recessed portion of the casing 13.

### Comparative Example

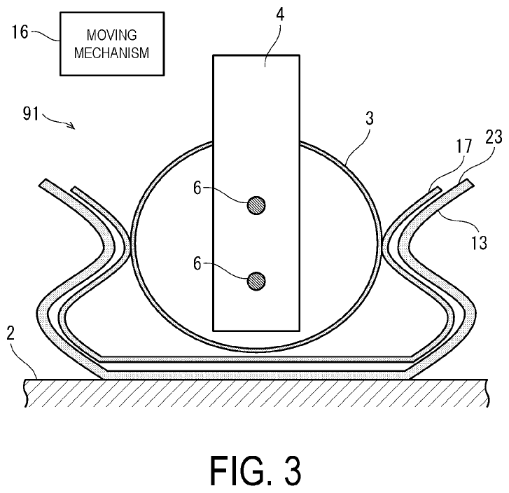

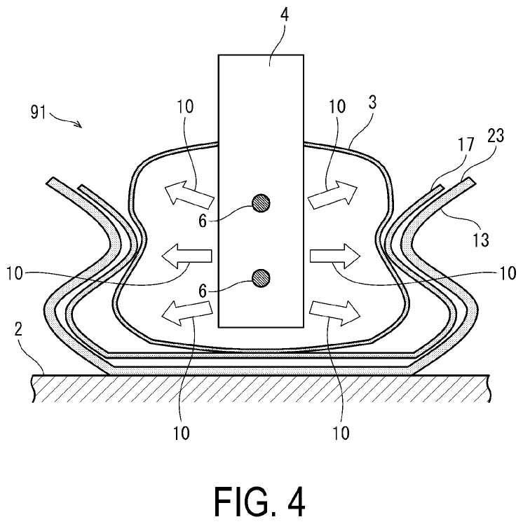

FIG. 3 is a sectional view schematically illustrating a configuration of a film applying apparatus 91 according to a comparative example. FIG. 4 is a sectional view for explaining operations of the film applying apparatus 91. Components substantially the same as those described above are designated by the same reference numerals. Such components are not described in detail again here.

The film applying apparatus 91 according to the comparative example does not includes the push-out arm 5, the connecting member 15, and the control circuit 22. Except this matter, the configuration of the film applying apparatus 91 is similar to the configuration of the film applying apparatus 1 according to the first embodiment.

Referring to FIG. 3, first, the film 17 is supplied along the inner curved surface 23 of the casing 13. Then the air bag 3 moves into the casing 13. Next, as illustrated in FIG. 4, the air 10 is discharged from the air discharging ports 6, so that the air bag 3 is inflated. After that, the inflated air bag 3 presses the film 17 against the inner curved surface 23 of the casing 13, so that the film 17 is applied to the inner curved surface 23 of the casing 13.

However, discharging the air 10 from the air discharging ports 6 and thereby inflating the air bag 3 may not sufficiently press the film 17. For example, the film 17 may not reach the bottom portion of the lower recessed portion of the inner curved surface 23 of the casing 13. Similarly, the film 17 may not reach the upper recessed portion. In this case, a gap may be created, and in turn an air bubble may be produced between a part of the film 17, which not reaching the recessed portion of the inner curved surface 23, and the recessed portion of the inner curved surface 23.

In contrast, according to the first embodiment, the push-out arm 5 corresponding to the lower recessed portion of the inner curved surface 23 extends to push the film 17 toward the lower recessed portion of the inner curved surface 23. Thus, the film 17 is also sufficiently applied to the lower recessed portion of the inner curved surface 23.

Furthermore, the push-out arms 5 corresponding to the upper recessed portion of the inner curved surface 23 extend to push the film 17 toward the upper recessed portion. Thus, the film 17 is also sufficiently applied to the upper recessed portion of the inner curved surface 23.

As described above, when the air bag 3 is partially extended by the push-out arms 5 by design, no gap is created between the part of the film 17 which does not reach the recessed portion of the inner curved surface 23 of the casing 13 only by the air 10 and the recessed portion of the inner curved surface 23, whereby the problem that an air bubble is produced to cause deficiencies is solved.

The film applying apparatus 1 is for being implemented under vacuum. However, it may be implemented under atmospheric pressure or under reduced pressure. This also applies to the embodiments described later.

### Second Embodiment

### Configuration of Film Applying Apparatus 1A

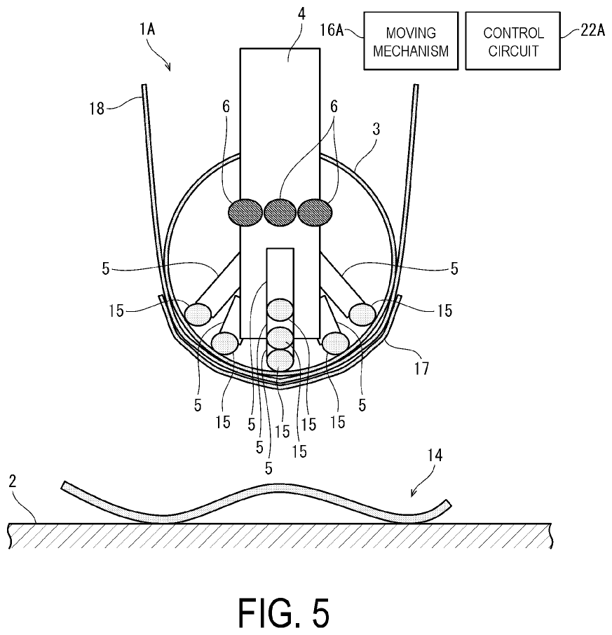

FIG. 5 is a sectional view schematically illustrating a configuration of a film applying apparatus 1A according to a second embodiment. Components substantially the same as those described above are designated by the same reference numerals. Such components are not described in detail again here.

The second embodiment is an application example to an OLED module (an EL device) in which a film 17 formed from an optical adhesive sheet (an OCA) is applied to a cover glass (CG) 14.

The film applying apparatus 1A includes a stage 2. A cover glass 14 (a target member) provided with a complexly-deformed curved surface is placed on the stage 2.

The film applying apparatus 1A includes an air bag 3. The air bag 3 is disposed at a position opposite the cover glass 14, which is placed on the stage 2, across a film 17 to be applied to an upper curved surface of the cover glass 14. A transfer sheet 18 is wound around the air bag 3 with the transfer sheet 18 facing the cover glass 14. The film 17 is disposed on the transfer sheet 18 at a position facing the cover glass 14.

The film applying apparatus 1A includes a supporting member 4 configured to support the air bag 3. The supporting member 4 is provided in a manner projecting toward the interior of the air bag 3. A plurality of air discharging ports 6 are formed in the supporting member 4. The air discharging ports 6 are configured to discharge the air 10 to inflate the air bag 3 such that the air bag 3 presses the film 17 against an upper curved surface of the cover glass 14 toward the inner surface of the air bag 3.

The supporting member 4 includes a plurality of push-out arms 5 configured to push the film 17 toward the upper curved surface of the cover glass 14. As illustrated in FIG. 5, the push-out arms 5 are rod-like extensible members positioned in a manner projecting obliquely downward toward the inner surface of the air bag 3 from the side surface of the supporting member 4 or in a manner projecting downward toward the inner surface of the air bag 3 from the lower surface of the supporting member 4.

At a distal end of each push-out arm 5, a connecting member 15 configured to connect the air bag 3 and the push-out arm 5 is disposed.

The push-out arms 5 disposed at the lower surface of the supporting member 4 are deployed at a position corresponding to the bulging portion of the upper curved surface of the cover glass 14. The push-out arm 5 disposed at the side surface of the supporting member 4 are provided at a position corresponding to the recessed portion adjacent the aforementioned bulging portion of the cover glass 14.

In the example illustrated in FIG. 5, one push-out arm 5 is disposed at the lower surface of the supporting member 4. Four pairs of vertically arranged push-out arm 5 are provided on the side surface of the supporting member 4. One of the four pairs of push-out arms 5 is positioned in a state projecting in a left obliquely downward direction as viewed in the drawing. One of the four pairs of push-out arms 5 is positioned in a state projecting in a right obliquely downward direction as viewed in the drawing. One of the four pairs of push-out arms 5 is positioned in a state projecting in a front obliquely downward direction as viewed in the drawing. One of the four pairs of push-out arms 5 is positioned in a state projecting in a back obliquely downward direction as viewed in the drawing and not illustrated in FIG. 5.

The film applying apparatus 1A includes a moving mechanism 16A. The moving mechanism 16A moves the supporting member 4 in the left-right direction and in the up-down direction so that the push-out arms 5 disposed at the lower surface of the supporting member 4 are deployed at a position corresponding to the bulging portion of the upper curved surface of the cover glass 14. A camera that recognizes the positions of the cover glass 14 and the air bag 3 may be provided to make alignment of the air bag 3 to the cover glass 14.

The film applying apparatus 1A includes a control circuit 22A. The control circuit 22A controls extension and retraction of the push-out arms 5 so that the film 17 is pushed toward the upper curved surface of the cover glass 14.

### Operations of Film Applying Apparatus 1A

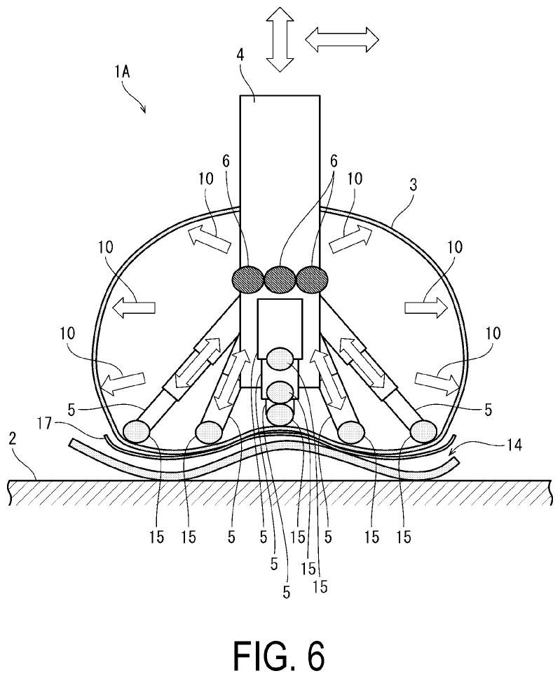

FIG. 6 is a sectional view for explaining operations of the film applying apparatus 1A.

The film applying apparatus 1 configured as described above operates as follows. Referring to FIG. 5, the transfer sheet 18 on which the film 17 is carried is supplied along the surface of the air bag 3 on the cover glass 14 side so that the film 17 faces the cover glass 14. Then, the moving mechanism 16A vertically and horizontally moves the supporting member 4 so that the push-out arms 5 disposed at the lower surface of the supporting member 4 are deployed at a position corresponding to the bulging portion of the upper curved surface of the cover glass 14.

Next, as illustrated in FIG. 6, the air 10 is discharged from the air discharging ports 6, so that the air bag 3 is inflated. After that, the push-out arms 5 disposed at the lower surface of the supporting member 4 extend downward, so that the film 17 is pushed toward the bulging portion of the upper curved surface of the cover glass 14. Thus, the film 17 is sufficiently applied to the bulging portion of the cover glass 14.

Then, the four lower-side push-out arms 5 among the four pairs of push-out arms 5 disposed on the side surface of the supporting member 4 respectively extend in the left obliquely downward direction, the right obliquely downward direction, the front obliquely downward direction, and the back obliquely downward direction, as viewed in the drawing, so that the film 17 is pushed toward the sites of the recessed portions adjacent the bulging portion of the cover glass 14.

Next, the four upper-side push-out arms 5 among the four pairs of push-out arms 5 respectively extend in the left obliquely downward direction, the right obliquely downward direction, the front obliquely downward direction, and the back obliquely downward direction, as viewed in the drawing, so that the film 17 is pushed toward the sites of the recessed portions remote from the bulging portion of the cover glass 14. As a result, the film 17 is also sufficiently applied to the recessed portions of the cover glass 14.

As such, first, the four lower push-out arms 5 disposed at the side surface of the supporting member extend in obliquely downward, and then, the four upper push-out arms 5 extend in obliquely downward. Therefore, the film 17 may be sequentially applied to the cover glass 14 from the bulging portion of the curved surface of the cover glass 14 toward the outside.

The control circuit 22A may be configured to control multiple motions of the supporting member 4 in the up-down direction and left-right direction, extension and retraction of the push-out arms 5, and motions from an inflation of the air bag 3 by the air 10 so that the air bag 3 is continuously changed or inflated to an arbitrary shape in order to control the sites and order that the plurality of the push-out arm 5 press the film 17, when the film 17 is applied to the cover glass 14.

For example, a case in which an OCA is applied to a cover glass 14 for a peripheral curved surface of a smart phone will be described. The cover glass 14 has a central portion formed with a flat surface, and peripheral corner portions formed with a curved surface.

First, the moving mechanism 16A moves the supporting member 4 to a position above the central portion of the cover glass 14. Then, the control circuit 22 causes the push-out arms 5 to extend. This allows the air bag 3 to contact the central portion of the cover glass 14. The, the control circuit 22A causes the air 10 to be discharged from the air discharging ports 6, so that the air bag 3 is inflated. As a result, the film 17 formed from the OCA is pressed against the central portion of the cover glass 14. Next, the control circuit 22A causes other push-out arms 5 to extend, so that the air bag 3 contacts the peripheral corner portions of the cover glass 14. After that, the film 17 formed from the OCA is pressed against the peripheral corner portions of the cover glass 14.

The film applying apparatus may be configured without the connecting member 15 so that the distal ends of the push-out arms 5 do not connect with the air bag 3. Furthermore, the connecting members 15 may be provided at only the push-out arms 5 disposed at the lower part of the supporting member 4.

The film applying apparatus may be configured to draw the air 10 as well as to discharge the air 10 through the air discharging ports 6 of the supporting member 4. The air bag 3 may be changed to an arbitrary shape at an arbitrary timing by controlling the discharging timing and the drawing timing of the air 10.

The push-out arms 5 may be configured so that the air 10 is discharged and drawn at the distal ends thereof. An air discharging port and an air drawing port may be formed in the connecting member 15. A member in which the air discharging port and the air drawing port are formed may be provided near the connecting member 15.

### Comparative Example

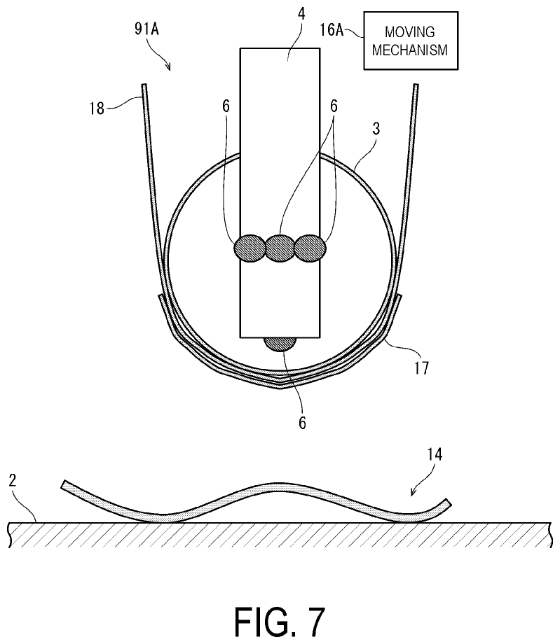

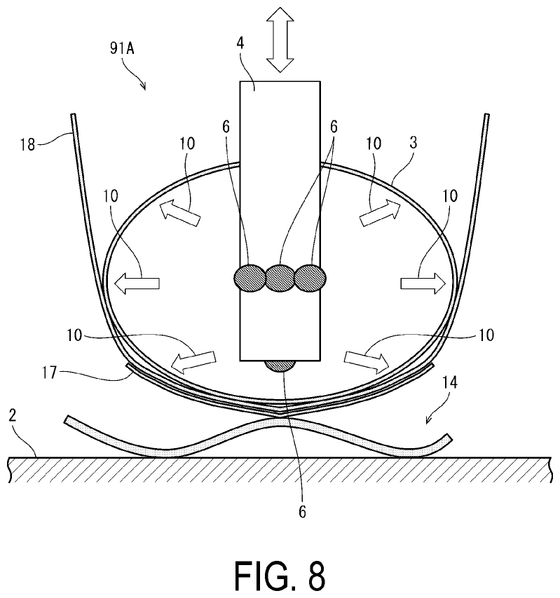

FIG. 7 is a sectional view schematically illustrating a configuration of a film applying apparatus 91A according to another comparative example. FIG. 8 is a sectional view for explaining operations of the film applying apparatus 91A. Components substantially the same as those described above are designated by the same reference numerals. Such components are not described in detail again here.

The film applying apparatus 91A according to the comparative example does not includes the push-out arm 5, the connecting member 15, and the control circuit 22. Except this matter, the configuration of the film applying apparatus 91A is similar to the configuration of the film applying apparatus 1A according to the second embodiment.

Referring to FIG. 7, the transfer sheet 18 on which the film 17 is carried is supplied along the surface of the air bag 3 on the cover glass 14 side so that the film 17 faces the cover glass 14. Then, the moving mechanism 16A moves the supporting member 4 so that the supporting member 4 is disposed on the position corresponding to the bulging portion of the upper curved surface of the cover glass 14.

Next, as illustrated in FIG. 8, the air 10 is discharged from the air discharging ports 6, so that the air bag 3 is inflated. Then, the film 17 is pressed against the upper curved surface of the cover glass 14 by the inflated air bag 3 and vertical motion of the supporting member 4, so that the film 17 is applied to the curved surface of the cover glass 14.

However, discharging the air 10 from the air discharging ports 6 and thereby inflating the air bag 3 may not sufficiently press the film 17. For example, the film 17 may not reach the recessed portions of the upper curved surface of the cover glass 14. In this case, a gap may be created, and in turn an air bubble may be produced between a part of the film 17, which is not reaching the recessed portion of the cover glass 14, and the recessed portion of cover glass 14.

In contrast, according to the second embodiment, a plurality of push-out arms 5 disposed at the side surface of the supporting member 4 in a manner corresponding to the recessed portion of the cover glass 14 extend, so that the film 17 is pushed toward the recessed portions of the cover glass 14. Thus, the film 17 is also sufficiently applied to the recessed portions of the cover glass 14.

As described above, when the air bag 3 is partially extended by the push-out arms 5 by design, no gap is created between the part of the film 17 which does not reach the recessed portions of the cover glass 14 only by the air 10 and the recessed portions of the cover glass 14, whereby the problem that an air bubble is generated to cause deficiencies is solved.

### Supplement

A film applying apparatus according to a first aspect includes a stage configured to place a target member on the stage, a curved surface being formed on the target member, an air bag disposed on a position facing the curved surface across a film, the film being applied to the curved surface of the target member placed on the stage, a supporting member configured to support the air bag; and one or more push-out arms disposed at the supporting member such that the one or more push-out arms projects toward an inner surface of the air bag to press the film toward the curved surface formed in the target member.

According to a second aspect, an air discharging port is formed in the supporting member, the air discharging port being configured to discharge air to inflate the air bag such that the film is pressed against the curved surface.

According to a third aspect, the one or more push-out arms press the film toward a recessed portion in the curved surface.

According to a fourth aspect, an optical element is formed on the film, and the target member is a cover glass.

According to a fifth aspect, the film applying apparatus includes a plurality of push-out arms, wherein the film applying apparatus further includes a moving mechanism configured to move the supporting member to a position corresponding to a bulging portion in the curved surface formed on the target member, one of the plurality of push-out rms is configured to press the film toward the bulging portion, and one of the plurality of push-out arms is configured to press the film toward a recessed portion adjacent the bulging portion.

According to a sixth aspect, an air discharging port or an air drawing port is formed in the one or more push-out arms, the discharging port being configured to discharge the air to inflate the air bag such that the film is pressed against the curved surface, and the air drawing port being configured to draw the air to deflate the air bag.

According to a seventh aspect, a connecting member configured to connect the air bag with the one or more push-out arms is disposed at a distal end of the one or more push-out arms, and an air discharging port or an air drawing port is formed at or near the connecting member, the discharging port being configured to discharge the air to inflate the air bag such that the film is pressed against the curved surface, and the air drawing port being configured to draw the air to deflated the air bag.

An Electroluminescence (EL) device manufacturing apparatus according to an eighth aspect includes a stage configured to place a cover glass on the stage, a curved surface being formed on the cover glass, an air bag disposed on a position facing the curved surface across a film, the film being applied to the curved surface of the cover glass placed on the stage, and a supporting member configured to support the air bag, wherein an EL element is formed on the film, and the EL device manufacturing apparatus further includes one or more push-out arms disposed at the supporting member so that one or more push-out arms projects toward an inner surface of the air bag to press the film toward the curved surface formed in the cover glass.

An EL device manufacturing method according to a ninth aspect includes: placing a cover glass on a stage, a curved surface being formed on the cover glass, and positioning an air back supported by a supporting member at a position facing the curved surface across a film, the film being applied to the curved surface of the cover glass placed on the stage, wherein an EL device is formed on the film, and the EL device manufacturing method further includes: pressing the film toward the curved surface formed in the cover glass by one or more push-out arms disposed at the supporting member in a manner projecting toward an inner surface of the air bag while inflating the air bag to press the film against the curved surface.

A controller according to a tenth aspect is a controller configured to control the EL device manufacturing apparatus according to the eighth aspect, including a control circuit configured to control the one or more push-out arms so that the one or more push-out arms pushes the film toward the curved surface formed on the cover glass.

The disclosure is not limited to each of the embodiments stated above, and various modifications may be implemented within a range not departing from the scope of the claims. Embodiments obtained by appropriately combining technical approaches stated in each of the different embodiments also fall within the scope of the technology of the disclosure. Moreover, novel technical features may be formed by combining the technical approaches stated in each of the embodiments.

### REFERENCE SIGNS LIST

1 Film applying apparatus

2 Stage

3 Air bag

4 Supporting member

5 Push-out arm

6 Air discharging port

10 Air

13 Casing (target member)

14 Cover glass (target member)

15 Connecting member

16 Moving mechanism

17 Film

22 Control circuit

1. A film applying apparatus comprising:
a stage configured to place a target member on the stage, a curved surface being formed on the target member;
an air bag disposed on a position facing to the curved surface across a film, the film being applied to the curved surface of the target member placed on the stage;
a supporting member configured to support the air bag; and
one or more push-out arms disposed at the supporting member such that the one or more push-out arms project toward an inner surface of the air bag to press the film toward the curved surface formed in the target member.

2. The film applying apparatus according to claim 1,
wherein an air discharging port is formed in the supporting member, the air discharging port being configured to discharge air to inflate the air bag such that the air back presses the film against the curved surface.

3. The film applying apparatus according to claim 1,
wherein the one or more push-out arms is configured to press the film toward a recessed portion in the curved surface.

4. The film applying apparatus according to claim 1,
wherein an optical element is formed on the film, and
the target member is a cover glass.

5. The film applying apparatus according to claim 1, comprising a plurality of push-out arms,
wherein the film applying apparatus further comprises a moving mechanism configured to move the supporting member to a position corresponding to a bulging portion in the curved surface formed on the target member,
one of the plurality of push-out arms is configured to press the film toward the bulging portion, and
one of the plurality of push-out arms is configured to press the film toward a recessed portion adjacent the bulging portion.

6. The film applying apparatus according to claim 1,
wherein an air discharging port or an air drawing port is formed in the one or more push-out arms, the discharging port being configured to discharge the air to inflate the air bag such that the film is pressed against the curved surface, and the air drawing port being configured to draw the air to deflate the air bag.

7. The film applying apparatus according to claim 1,
wherein a connecting member configured to connect the air bag with the one or more push-out arms is disposed at a distal end of the one or more push-out arms, and
an air discharging port or an air drawing port is formed at or near the connecting member, the discharging port being configured to discharge the air to inflate the air bag such that the film is pressed against the curved surface, and the air drawing port being configured to draw the air to deflate the air bag.

8. An Electroluminescence (EL) device manufacturing apparatus comprising:
a stage configured to place a cover glass on the stage, a curved surface being formed on the cover glass;
an air bag disposed in a position facing the curved surface across a film, the film being applied to the curved surface of the cover glass placed on the stage; and
a supporting member configured to support the air bag,
wherein an EL element is formed on the film, and
the EL device manufacturing apparatus further comprises one or more push-out arms disposed at the supporting member so that one or more push-out arms project toward an inner surface of the air bag to press the film toward the curved surface formed on the cover glass.

9. An EL device manufacturing method comprising:
placing a cover glass on a stage, a curved surface being formed on the cover glass; and
positioning an air back supported by a supporting member at a position facing the curved surface across a film, the film being applied to the curved surface of the cover glass placed on the stage,
wherein an EL device is formed on the film, and
the EL device manufacturing method further comprises pressing the film toward the curved surface formed on the cover glass by one or more push-out arms disposed at the supporting member in a manner projecting toward an inner surface of the air bag while inflating the air bag to press the film against the curved surface.

10. A controller configured to control the EL device manufacturing apparatus according to claim 8, the controller comprising a control circuit configured to control the one or more push-out arms so that the one or more push-out arms pushes the film toward the curved surface formed on the cover glass.
